(19) United States
(12) Patent Application Publication
(10) Pub. No.: US 2005/0286443 A1
(43) Pub. Date: Dec. 29, 2005

(54) Conferencing system

(75) Inventors: Keith McMillen, Berkeley, CA (US); Richard Hodges, Oakland, CA (US); Keith Edwards, Antioch, CA (US)

Correspondence Address: BEYER WEAVER & THOMAS LLP, P.O. BOX 70250, OAKLAND, CA, 94612-0250, US

(73) Assignee: Octiv, Inc., Berkeley, CA (US)

(21) Appl. No.: 10/996,879

(22) Filed: Nov. 24, 2004

Related U.S. Application Data
(63) Continuation-in-part of application No. 10/881,992, filed on Jun. 29, 2004.

(51) Int. Cl. H04L 12/16

(52) U.S. Cl. 370/260; 370/352

(57) ABSTRACT

A conferencing system is described which includes a plurality of conferencing devices and a hub device. Each conferencing device is operable to process near-end speech energy signals to improve the intelligibility of the near-end speech, transmit the processed near-end signals to the hub device, receive far-end signals from the hub device, process the far-end signals, and present the processed far-end signals over its speaker. The hub device is operable to communicate with each of the conferencing devices and a voice communication system, selectively combine the processed near-end signals received from the conferencing devices, transmit the combined near-end signals to the voice communication system, receive the far-end signals from the voice communication system, and transmit the far-end signals to the conferencing devices.

### RELATED APPLICATION DATA

The present application is a continuation-in-part of and claims priority under 35 U.S.C. 120 to U.S. patent application Ser. No. 10/881,992 filed on Jun. 29, 2004 (Attorney Docket No. OCTVP009), the entire disclosure of which is incorporated herein by reference for all purposes.

### BACKGROUND OF THE INVENTION

The present invention relates to digital signal processing of audio signals, and more particularly to techniques, devices and systems for facilitating high quality, full duplex teleconferencing.

Anyone who participates in teleconferencing is aware of the shortcomings of the vast array of technology offerings in this area. Many conference phones provide half duplex operation in which only one end of the conversation can speak at a time. This unnatural, “walkie-talkie” conversational style has proven to be a significant impediment to the acceptance and use of such solutions.

On the other hand, systems purporting to offer full duplex operation often suffer from echo or feedback (which causes howling and other undesirable artifacts) unless appropriate signal processing techniques are applied. However, the application of such techniques often results in a user experience which is not significantly better than brute force half duplex solutions.

Another shortcoming associated with many conferencing systems is the quality of the audio delivered. That is, many systems deliver poor quality audio that is either distorted in some way, or all but unintelligible due to background noise or inadequate hardware. This is particularly the case for many voice applications for personal computers.

Moreover, the high quality large-room conference systems which are currently available are not appropriate for many applications. For example, there is a significant demand for hands free operation in individual offices where the deployment of such systems would be inappropriate or impractical. On the other hand, the poor quality and half-duplex operation found on most speakerphones, or the inadequacies of many voice over IP (VoIP) applications are not conducive for “serious” or long term phone conversations.

It is therefore desirable to provide. conferencing solutions which address these shortcomings, and which may be flexibly configured for a wide range of applications including single office and conference room deployment.

### SUMMARY OF THE INVENTION

According to the present invention, a conferencing system is provided which includes a plurality of conferencing devices and a hub device. Each conferencing device includes a speaker, at least one microphone for capturing energy corresponding to near-end speech, a hub interface, and a first digital processor. The first digital processor is operable to process near-end signals corresponding to the near-end speech energy to improve intelligibility thereof, and transmit the processed near-end signals via the hub interface. The first digital processor is further operable to receive far-end signals via the hub interface, process the far-end signals, and transmit the processed far-end signals for presentation over the speaker. The hub device includes a plurality of node interfaces operable to communicate with the hub interfaces of the conferencing devices, a voice system interface operable to communicate with a voice communication system, and a second digital processor. The second digital processor is operable to selectively combine the processed near-end signals received from the conferencing devices, transmit the combined processed near-end signals to the voice communication system via the system interface, receive the far-end signals from the voice communication system via the system interface, and transmit the far-end signals to the conferencing devices via the node interfaces. According to some embodiments, user interface control signals (e.g., mute and volume control) are transmitted.

A further understanding of the nature and advantages of the present invention may be realized by reference to the remaining portions of the specification and the drawings.

### BRIEF DESCRIPTION OF THE DRAWINGS

FIG. 1 is a simplified block diagram of an exemplary conferencing device designed according to a specific embodiment of the invention.

FIG. 2 is a simplified block diagram illustrating the signal processing functions associated with an exemplary conferencing device designed according to a specific embodiment of the invention.

FIG. 2a is a simplified block diagram illustrating an alternative configuration for a portion of the conferencing device illustrated in FIG. 2.

FIG. 3 is a perspective view of an exemplary conferencing device designed according to a specific embodiment of the invention.

FIG. 4 is a cross-sectional view of the conferencing device of FIG. 3.

FIG. 5 is a perspective view of an exemplary conferencing system designed according to a specific embodiment of the invention.

FIG. 6 is a simplified block diagram of an exemplary conferencing system designed according to a specific embodiment of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

According to the invention, a conferencing system is provided which provides full duplex operation and generates high quality audio. According to specific embodiments, a “personal conferencing node” is provided which may be easily deployed on a desk top and may be integrated with a variety of voice communication systems including, for example, analog and digital phone systems, wireless communication devices, and a wide variety of software-based voice applications. According to some embodiments, multiple conferencing nodes are combined to form a conferencing system which may be deployed in larger environments, e.g., conference rooms.

According to some embodiments, the conferencing node is connected in series with a phone handset which needs to be picked up to provide the analog signals to the conferencing node. The signals go through the conferencing node to the handset unless the conferencing node is activated, in which case, the handset is cut off. If the conferencing node is connected to a wireless device, e.g., a cell phone, the wireless device user can use the conferencing node by answering the call with the wireless device, e.g., pressing the “send” button, and then activating the conferencing node.

The analog signals from the phone are typically carried on four wires; two wires from the phone to the speaker in the handset, and two wires from the microphone in the handset to the phone. In such embodiments, the placement of the conferencing node between the phone and the handset takes advantage of the fact that the signals are already separated, thereby avoiding having to include circuitry for separating the signals, e.g., a hybrid circuit, in the device itself. These embodiments also leverage the ring voltage and tone circuitry in the phone which therefore do not need to be provided in the conferencing node.

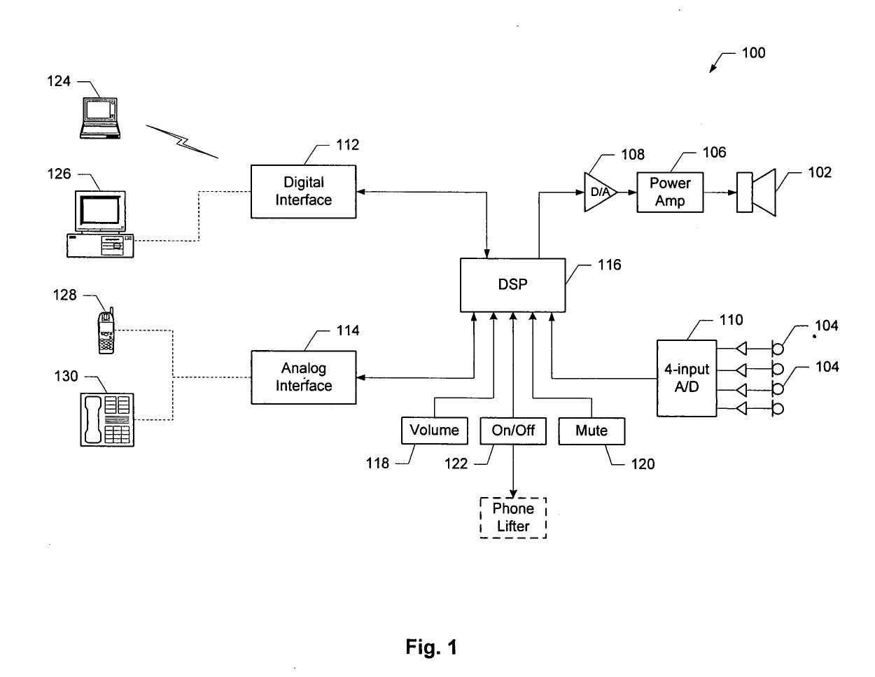

According to some embodiments in which the conferencing node is placed between a phone and its handset, the handset may be lifted automatically (to thereby complete the call circuit) in response to activation of the device. For example, in response to hearing the phone ring or in preparation for making a call, a user could activate the device (e.g., by pressing a button on the device) in response to which a mechanical handset lifter raises the handset out of its cradle sufficiently to answer or begin the call. The same device activation mechanism may be employed to cause the handset lifter to lower the handset into the cradle and terminate the call (e.g., see FIG. 1). Similar wireless embodiments are contemplated in which activation and deactivation of the conferencing node begins and terminates calls.

The typical hybrid employed by a telephone to separate incoming and outgoing signals provides approximately 6 to 18 dB of return loss between outgoing and incoming signals. This results in so-called side tones which are manifested, for example, as the sound of one's own voice in the handset speaker. While this degree of separation may be sufficient (and even desirable) for the typical handset, a much greater degree of separation may be desirable for other applications, e.g., conferencing. In addition, greater return loss may be required to eliminate feedback and howling. Therefore, according to some embodiments, additional echo cancellation circuitry is provided in the device to provide a much higher separation between incoming and outgoing signals than is typically provided by the phone's hybrid. This will be discussed in further detail below.

According to some embodiments, the conferencing node of the present invention connects with a personal computer or other digital device (e.g., using USB (1 or 2), Bluetooth, variants of 802.11, or other wireless techniques) and interacts with “soft phone” software on the digital device. This includes any application (H323, SIP, etc.) that allows 2-way communication using a headset or free-air speakers and microphone. In such embodiments, for example, a simple video conferencing system can be implemented using the conferencing node and an inexpensive camera. As will be seen, embodiments of the present invention also provide multi-band digital signal processing of the incoming and outgoing voice signals to result in a very high quality user experience. This to be contrasted with the typically poor user experience associated with many “voice over IP” (VoIP) applications which employ low quality free-air microphones and multimedia speakers with little or no signal processing. In fact, the user experience has been so bad for such applications that many providers of Internet conferencing services have forced their users to go back to using phones for the audio portions of such conferences.

Embodiments of the present invention may also be employed with digital phones systems including, for example, all digital PBX phones such as Nortel, Siemens, Panasonic, ATT, etc. More generally, the present invention may be implemented in conjunction with any voice communication system which digitally encodes speech energy. All that is required for compatibility is appropriate coding and decoding at the interface.

According to a specific embodiment shown in FIG. 1, a hands-free conferencing device is provided which, with minor variations to its interface circuitry, may be implemented for both digital and analog implementations. Conferencing node 100 has a speaker 102 and a plurality (in this case 4) of microphones 104. Speaker 102 is driven by a power amplifier 106 which, in turn, is driven by digital-to-analog (D/A) converter 108. The signals from microphones 104 are received and converted to digital form by a multi-input analog-to-digital (A/D) converter 110.

As discussed above, conferencing node 100 may be configured to receive and transmit digital data or packets over wired (e.g., USB 1 or 2) or wireless (e.g., Bluetooth or 802.11) interfaces from any of a variety of digital devices (e.g., computers 124 and 126). In such embodiments, the packets may be received and transmitted using a digital interface (e.g., a chip set) 112 which can handle the protocol and/or data format according to which the packets are transmitted. For example, interface 112 may comprise a USB or Bluetooth media access control (MAC) chip set. In the case of a wireless embodiment, a suitable antenna or infrared interface (not shown) would be provided for transmitting and receiving the packets. In general, the nature of interface 112 may be as varied as the available digital solutions in this area.

Alternatively, conferencing node 100 may be configured to receive and transmit analog signals, e.g., two-wire or four-wire signals from a desktop or wireless phone handset (e.g., phones 128 and 130). In the four-wire case, interface 114 (e.g., a codec) makes the necessary signal conversions to and from the digital domain. In the two-wire case, a hybrid circuit (not shown) may also be provided to separate the incoming and outgoing signals.

Conferencing node 100 also includes a digital signal processor (DSP) 116 which controls the operation of the device. DSP 116 may be one or multiple general purpose processors, controllers, PLDs, FPGAs, or any other suitable data processing device(s), programmed with associated computer program instructions to perform the functionalities described herein. According to a specific embodiment, DSP 116 is implemented using a 21262 “SHARC” DSP from Analog Devices, Inc. Depending on the embodiment, DSP 116 interfaces with either interface 112 or 114. DSP 116 also provides digital audio data to D/A converter 108 for playing over speaker 102, and receives input from microphones 104 via A/D converter 110. DSP 116 also receives input from various user interface components including, for example, a volume encoder 118, a mute circuit/switch 120, and an on/off circuit 122.

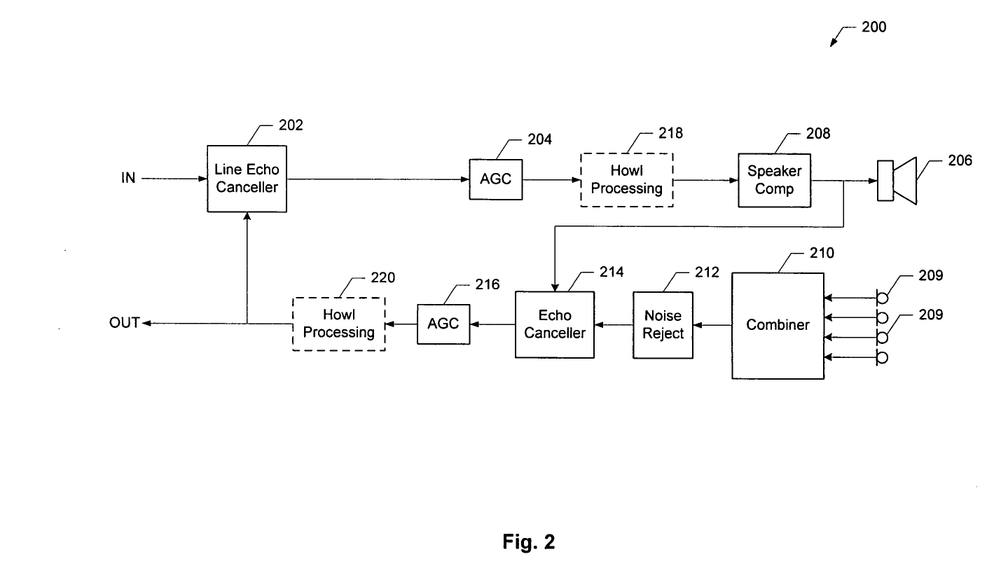

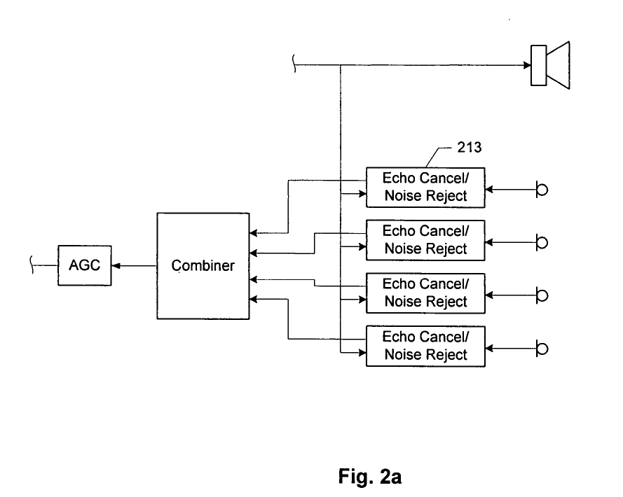

Operation of a specific embodiment of the conferencing node 200 of the present invention will now be described with reference to the functional block diagram of FIG. 2. It will be understood that most of the functional blocks shown and functions described may be implemented, for example, with DSP 116 of FIG. 1.

A line echo canceller 202 may be used to receive the incoming voice from the far side of the conversation. Any of a wide variety of echo cancellation techniques may be employed. And it will be understood that this will be more appropriate for analog embodiments in which additional separation between incoming and outgoing signals is desirable, but may not be needed for digital applications, e.g., PC soft phones, in which the separation issue does not arise.

An automatic gain control (AGC) block 204 provides processing of the far-end speech to improve the quality of the sound delivered by speaker 206. According to various embodiments, the nature of this processing may vary considerably without departing from the scope of the invention. According to a specific embodiment, AGC 204 provides multiband processing of the received signal and is implemented according to the techniques described in U.S. patent application Ser. No. 10/214,944 for DIGITAL SIGNAL PROCESSING TECHNIQUES FOR IMPROVING AUDIO CLARITY AND INTELLIGIBILITY filed on Aug. 6, 2002 (Attorney Docket No. OCTVP001X1), and U.S. patent application Ser. No. 10/696,239 for TECHNIQUES FOR IMPROVING TELEPHONE AUDIO QUALITY filed on Oct. 28, 2003 (Attorney Docket No. OCTVP008), the entire disclosures of both of which are incorporated herein by reference for all purposes.

According to a specific embodiment, a speaker compensation block 208 is also provided to compensate for the non-ideal characteristics of speaker 206. Again, it should be noted that such compensation is not required, and the nature of this compensation may vary widely without departing from the scope of the invention. According to one embodiment, speaker compensation block 208 comprises a minimum phase filter. A matched filtering technique is used to measure the impulse response of the speaker. An algorithm (such as the Prony algorithm) may then be used to make a linear system model representing the poles and zeros of the measured response. A compensating filter can then be derived by converting the poles into zero and the zeros into poles.

However, any zeros lying outside the unit circle in the z-plane have the potential to become unstable poles. Therefore, the linear system model is first converted to a minimum phase form using standard techniques before the compensating filter is derived. According to a particular implementation, this conversion is effected through the use of an all-pass filter which converts all of the zeros outside the unit circle into zeros inside the unit circle. The resulting model may then be inverted to derive a minimum phase filter which provides highly precise compensation for the non-ideal characteristics of the speaker. This approach is particularly effective in that it is able to compensate for irregularities of the speaker response in the frequency and time domains.

According to an even more specific embodiment, one or more additional filter components are added to the minimum phase filter to prevent undesirable compensation from occurring in certain regions of the audio spectrum. That is, it is undesirable for the minimum phase filter to attempt to compensate overly much for the natural roll off of the speaker at the low and high ends. For example, without additional filtering, the minimum phase filter might attempt to boost the low end bass by an infinite amount, resulting in clipping and/or other undesirable artifacts. Therefore, a high pass filter may be added to the minimum phase filter to limit the latter's action in these regions. Further, the minimum phase filter may be edited by hand in order to improve the subjective quality of the resulting audio, based on the experience and judgment of a signal processing scientist, by removing some poles and/or zeros and slightly modifying others.

It should be noted that speaker compensation may be achieved through a wide variety of other well known techniques. For example, techniques such as manual or automatic multi-band frequency equalization may be employed. Alternatively, speaker compensation may be omitted entirely.

In the implementation shown, the inputs from four microphones 209 are processed by a combiner block 210 which selects from among or combines the inputs from the different microphones in some way to generate a single signal. The algorithm employed by combiner block 210 may vary widely. For example, combiner block 210 may be a simple summing of the inputs from the different microphones. Alternatively, more sophisticated approaches may be employed. For example, combiner block 210 may be operable to pass only the input from one of the microphones based upon a determination as to which microphone is currently the most relevant, e.g., the microphone nearest the person currently speaking. According to one embodiment, combiner block 210 employs a beam forming algorithm which attempts to achieve an optimal linear combination of the various microphone inputs in order to emphasize sound coming from one direction and reject sound coming from other directions.

A noise rejection block 212 may also be employed to mitigate the effects of various types of noise in the system. According to various embodiments, block 212 may employ any of a wide variety of techniques which attempt to separate the desirable signal, i.e., speech from the person currently talking, from various sources of interference, e.g., peripheral noise, far end-speech, etc. Such techniques may include the use of, for example, Wiener filters, noise gates, spectral subtraction, and other techniques known in the art.

According to the embodiment shown, echo cancellation block 214 receives information from the signal being transmitted to speaker 206 and attempts to reject energy in the signal received from the microphones which corresponds to the acoustic energy from the speaker. The complete or at least partial cancellation of this energy allows the conferencing node of the present invention to operate in a true full duplex mode, i.e., both near-end and far-end participants in a conference can speak and be heard at the same time.

AGC block 216 provides processing of the near-end speech (i.e., speech captured by the microphones) to improve the quality of the sound delivered to the far-end participants. As discussed above with reference to AGC block 204, the nature of this processing may vary considerably without departing from the scope of the invention. According to a specific embodiment, AGC 216 provides multi-band processing and is implemented according to the techniques described in U.S. patent application Ser. Nos. 10/214,944 and 10/696,239 incorporated herein by reference above.

A common problem with many phone systems, even those with sophisticated echo cancellation, is the occurrence of howling under certain conditions. Howling is caused by a feedback condition in which acoustic energy from a system's speaker is captured by the microphone(s) and fed back around the loop to the speaker. Therefore, according to some implementations, howl processing blocks 218 and 220 may be introduced to mitigate this condition.

According to a specific embodiment, blocks 218 and 220 implement complementary comb filters which selectively pass frequency bands in one direction which are complementary to the frequency bands being passed in the other direction. As will be appreciated, this will serve to knock down the frequencies which are being fed around the loop under conditions in which howling might otherwise occur. In order to mitigate any potential negative effects on the quality of the audio delivered by the system, the complementary comb filters may be activated only where there is speech detected from both ends of a conversation, i.e., the “doubletalk” condition during which howling is most likely to occur. In other specific embodiments, the entire incoming and/or outgoing signals may be shifted slightly in frequency using well known side-band modulation techniques.

The signal processing blocks of FIG. 2 are shown and described with references to functionalities which are presented as being discrete for purposes of clarity. However, it will be understood that the various processing blocks shown may be combined in various ways without departing from the scope of the invention. For example, combiner block 210, noise rejection block 212, and echo cancellation block 214 may be implemented in a single or multiple blocks of code.

In addition, the order of the processing blocks may be altered from that described above without departing from the invention. For example, the echo cancellation and noise rejection functions represented by blocks 214 and 212 may be placed before the signal combining function represented by block 210 such that there are four echo cancellation blocks and/or four noise rejection blocks (e.g., blocks 213), i.e., one for each microphone as shown in FIG. 2a. In another exemplary variation, echo cancellation and/or noise rejection is provided both before and after the signal combining function. Those of skill in the art will understand the wide variety of other alternative configurations and combinations which are within the scope of the invention.

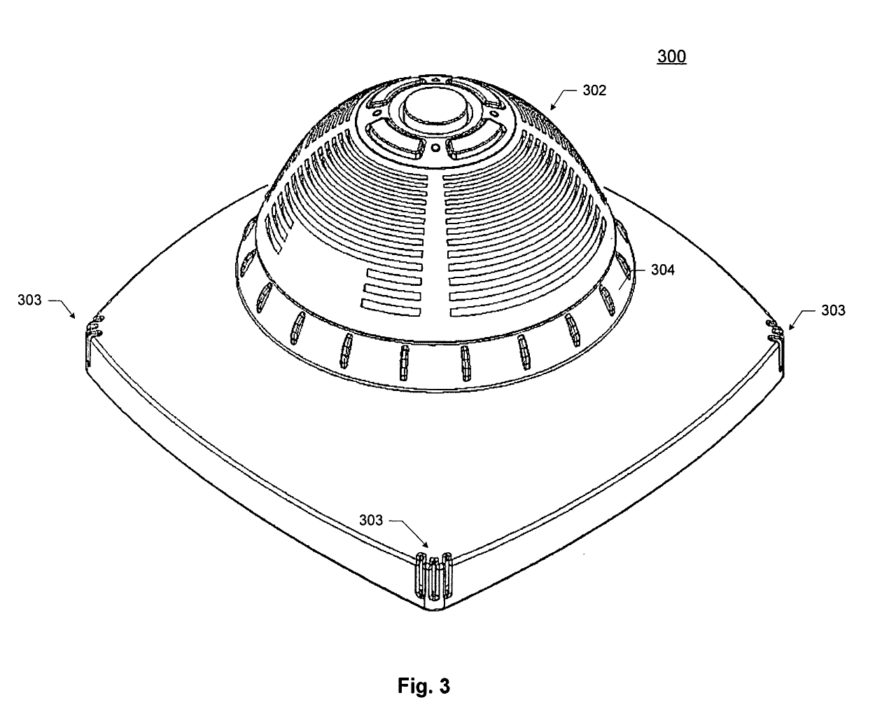

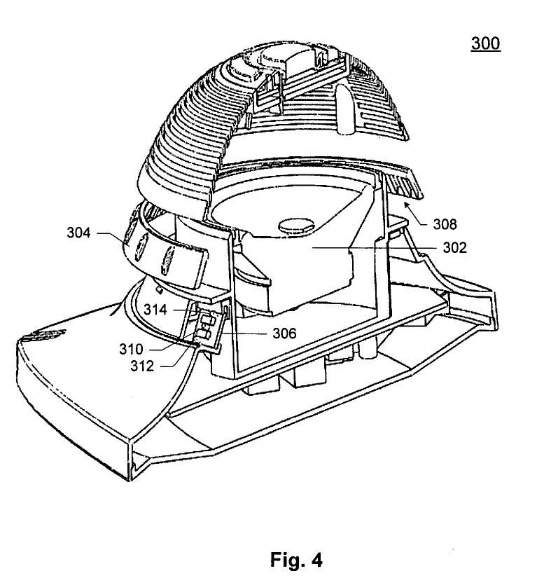

FIG. 3 is a perspective view of an exemplary conferencing device 300. FIG. 4 is a cross-sectional view of conferencing device 300. According to a specific embodiment, a personal conferencing node 300 has an upward-facing speaker 302, and a microphone 303 at each of the four corners of the square base of the device. The high dome shape makes it less likely that the device becomes covered with paper, even on the most cluttered of desks. A volume control signal for controlling the volume of speaker 302 is generated using volume control ring 304 and volume encoder board 306. Ring 304 is mounted such that it can be rotated around the central vertical axis of the device to increase or decrease the volume. Ring 304 has ridges, marks, or openings 308 spaced at regular intervals along its inner surface. Volume encoder board 306 has a light source 310, e.g., an LED, which shines light on the inner surface of ring 304, and two photo detectors 312 and 314 which are offset and configured to receive the light reflected from the inner surface of ring 304. The photo detectors generate output signals which represent the variations in the reflected light caused by marks (or openings) 308 passing LED 310. The detector output signals, which encode the number of marks passing the LED, may then be converted into digital information which is used by the conferencing node's DSP to adjust the speaker volume accordingly. The direction of rotation of the ring (and thus the direction of volume adjustment up or down) may be determined by comparing the two detector outputs.

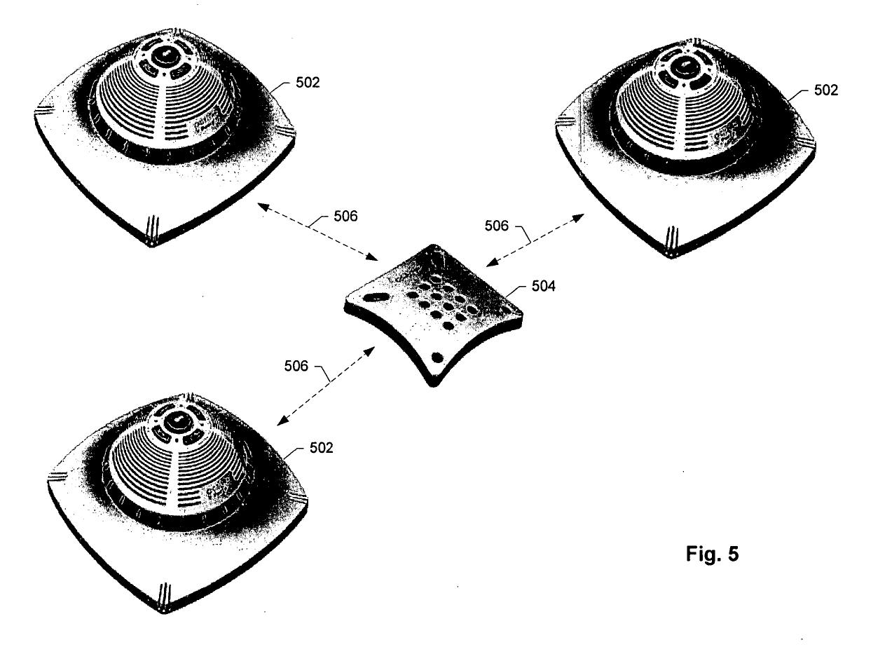

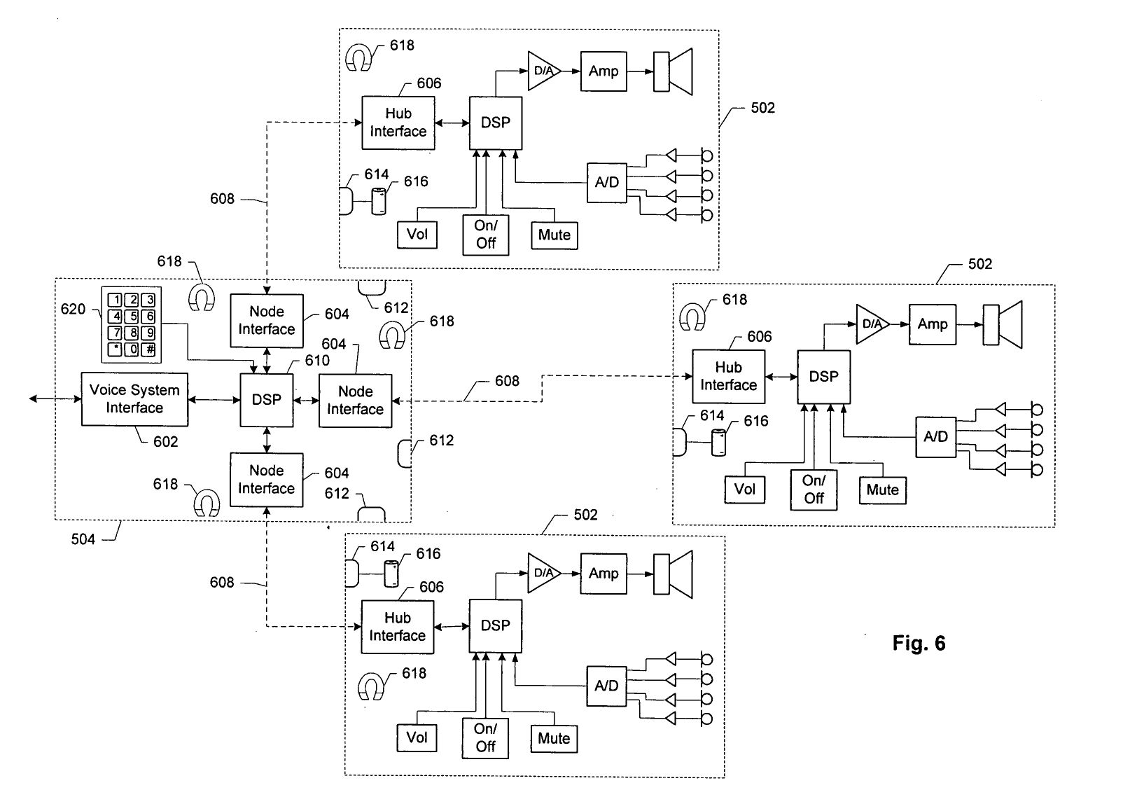

The personal conferencing node of the present invention may be scaled up to provide conferencing capabilities for larger acoustic environments, e.g., conference rooms. According to various embodiments represented by the exemplary system shown in FIGS. 5 and 6, an array including any number of conferencing nodes 502 are deployed at strategic locations in the acoustic environment, each in communication with a hub device 504. Conferencing nodes 502 may be configured to operate as described above with some or all of the described functionalities. Hub device 504 may also include volume control (e.g., a master volume control for all of the devices), a mute control, and a power switch for the entire system. In addition, hub device 504 may include some level of intelligence to selectively combine the audio and control signals received from conferencing nodes 502.

In such a system, the deployment of several speakers eliminates the audibility problem associated with having a single, centrally located speaker like many conventional conferencing systems. In addition, the controls located on each node allows any of the participants in a large conference to control the system, e.g., put the system on mute. The multi-node conferencing system provides the full duplex operation and high quality sound of the single node system.

According to various embodiments, conferencing nodes 502 may communicate with hub device 504 in a variety of ways. Dashed lines 506 each represent a set of bidirectional interfaces and transmission media which may be implemented using any of a wide variety of standard or proprietary, digital or analog, and wired or wireless technology. For example, the devices may communicate digitally with each other according to the Universal Serial Bus (USB) standard. Alternatively, the devices may communicate using infrared or radio frequency (RF) transmitters and receivers. In yet another alternative, wireless digital communication may be facilitated among the devices using, for example, Bluetooth technology.

Referring to FIG. 6, hub device 504 includes an interface 602 to the voice communication system (not shown) with which the system is intended to operate. As with the personal conferencing node described above, interface 602 may be configured to receive and transmit digital data or packets over wired (e.g., USB 1 or 2) or wireless (e.g., Bluetooth or 802.11) interfaces from any of a variety of digital devices. In such embodiments, the packets may be received and transmitted using, for example, a chip set which can handle the protocol and/or data format according to which the packets are transmitted. For example, interface 602 may comprise a USB or Bluetooth media access control (MAC) chip set. In the case of a wireless embodiment, a suitable antenna or infrared interface (not shown) would be provided for transmitting and receiving the packets. Alternatively, interface 602 may be configured to receive and transmit analog phone signals, e.g., two-wire or four-wire signals. In the four-wire case, interface 602 (e.g., using a codec) makes the necessary signal conversions to and from the digital domain. In the two-wire case, a hybrid circuit (not shown) may also be provided to separate the incoming and outgoing signals. In general, the nature of interface 602 may be as varied as the available analog and digital solutions in this area.

Hub device 504 also includes a plurality of node interfaces 604 by which hub device 504 communicates with hub interfaces 606 in each of conferencing nodes 502 via bidirectional transmission media 608. As discussed above with reference to dashed lines 506 in FIG. 5, the hub and node interfaces and the intervening transmission media may correspond to a variety of digital or analog, and wired or wireless technologies. According to one set of embodiments, the hub and node interfaces conform to the USB standard with audio and control signals being transmitted via a single USB cable. According to other embodiments, multiple signal lines or channels may be necessary for the transmission of the different signals.

Hub device 504 also includes a digital signal processor (DSP) 610 which may be, for example, the 21262 “SHARC” DSP provided by Analog Devices, Inc. As with DSP 116, DSP 610 may be one or multiple general purpose processors, controllers, PLDs, FPGAs, or any other suitable data processing device(s), programmed with associated computer program instructions to perform the functionalities described herein. According to various embodiments, DSP 610 may be configured to perform a variety of processing functionalities. According to a specific embodiment, DSP 610 is operable to emphasize or deemphasize the signal contributions from specific conferencing nodes so that the speech captured by the node nearest a speaker dominates what is transmitted to the other end of a call. That is, for example, the hub might determine that the signal from one of the nodes is significantly greater than from any of the others and, in response, ignore or “mute” the contributions from all of the nodes but that one. On the other hand, if the signal levels from multiple nodes were not significantly different, they might be mixed so that the speakers associated with each node could be heard. According to some embodiments, the hub device may employ sophisticated beam forming algorithms (e.g., as described above with reference to a single node) to combine the contributions from the different conferencing nodes.

According to specific embodiments, DSP 610 is operable to facilitate presentation of audio from the far-end of a conversation over the array of conferencing nodes to effect stereo or multi-channel sound. According to one such embodiment in which the far-end of the conversation is employing an array of conferencing nodes, DSP 610 is operable to present the multi-channel audio on the near end in such a way as to simulate different locations in the near-end acoustic environment for different speakers at the far end. That is, for example, if a speaker is at one end of a conference table at a far-end conference room (as indicated by the nearest conferencing node in the far-end system), that speaker's speech on the conferencing nodes of the near-end system would be selectively presented to simulate an analogous location in the near-end conference room.

According to such embodiments, DSP 610 of hub device 504 may also be configured to effect echo cancellation, either alone or in conjunction with echo cancellation performed by each of the conferencing nodes. As is known in the art, echo cancellation is difficult when there are multiple loudspeakers with different signals. This is because for many standard echo canceling algorithms the fact that similar but not identical signals from different sources are present causes the mathematical operations required to be what is called “ill-conditioned”, i.e., subject to large errors. Techniques have been described in the literature for making echo cancellation possible by reducing the similarity of the different speaker signals. Such techniques include slight frequency shifts in the signal sent to different speakers and complementary comb filters in the signals sent to different speakers. Alternatively, an audio “watermarking” technique may be employed to distinguish different acoustic components in an acoustic environment by inserting unique signal processing artifacts in specific signals. Such a technique is described in U.S. Provisional Patent Application No. 60/609,883 for WATERMARKING TECHNIQUE FOR SEPARATING SOUND FROM ENVIRONMENTAL NOISE filed on Sep. 13, 2004 (Attorney Docket No. OCTVP010P), the entire disclosure of which is incorporated herein by reference for all purposes.

The conferencing system of FIGS. 5 and 6 may be connected with the voice communication system (not shown) in any of the ways that an individual personal conferencing node may be so connected. That is, interface 602 and DSP 610 may be configured to enable hub device 504 to interact with a variety of voice communication systems including, for example, the PSTN, analog and digital PBX, VoIP, or any type of “soft phone.” Hub device 504 may even be configured to intercept the analog handset signals as described above with reference to one embodiment of the personal conferencing node.

According to specific embodiments, hub device 504 mimics the functionality of the voice communication system with which it is intended to interact. For example, if a company employs a digital PBX from a particular vendor (e.g., Nortel, Siemens, Panasonic, ATT, etc.), the digital PBX standard for that company (including some or all of its available functionality) may be implemented in the hub device. A conventional phone keypad 620 may also be provided to facilitate providing the functionalities of the voice communication system. A variety of additional functionalities such as, for example, redial, mute, flash, etc., may be included in the hub device with the addition of appropriate keys or buttons and the suitable programming of the device.

Power may be provided to the components of a conferencing system designed according to the invention in a variety of ways. According to one embodiment, the individual conferencing nodes employ battery power which is rechargeable when the nodes are brought into contact with the hub device which is connected to either DC or AC power. Referring once again to FIGS. 5 and 6, the edges of conferencing nodes 502 and hub device 504 fit together so that a charging mechanism (represented by components 612 and 614) may be engaged by which batteries 616 in nodes 502 are recharged while the nodes are in contact with hub 504. It should be noted that the specific type of battery employed and the nature of the appropriate charging circuitry are within the knowledge of one of skill in the art and are therefore not described in detail here. As will be understood, there are many commercially available batteries and chargers which may be employed for this purpose.

According to a specific embodiment, the charging mechanism employs an inductive charging technique by which magnetic fields generated by components 612 are experienced by components 614 which generate charging currents for batteries 616. Inductive charging techniques are currently used in several electric toothbrush models including Sonicare, and in the electric car model EV-1. Alternatively, components 612 and 614 may include direct electrical contacts by which the charging current for batteries 616 is delivered. Such systems are common, for example, for recharging most commercially available cordless phones.

Between calls, conferencing nodes 502 can be kept in contact with hub device 504 for charging. According to one embodiment, magnets 618 in conferencing nodes 502 and hub device 504 keep the devices in contact and help maintain the integrity of the connection or the necessary proximity for charging. When users desire to place a conference call, nodes 502 may be removed and deployed in any desired configuration.

According to other embodiments, electrical power is delivered to conferencing nodes via wires. This may be done using conventional electric power cords for each device. Alternatively, in embodiments in which the conferencing nodes communicate with the hub device via the USB standard, electrical power may be delivered to the nodes via the USB interfaces and cables. As will be understood, such implementations may require that the power to the node speakers be appropriately controlled to meet a power budget within the capabilities of a USB interface.

While the invention has been particularly shown and described with reference to specific embodiments thereof, it will be understood by those skilled in the art that changes in the form and details of the disclosed embodiments may be made without departing from the spirit or scope of the invention. For example, the conferencing nodes may be deployed in a variety of configurations without departing from the scope of the invention. According to one approach described above, the nodes are configured around a hub device with a hub and spoke or “star” configuration. Alternatively, the nodes could be configured in a daisy chain configuration with one device, e.g., the hub device, coupled to the voice communication system, and the conferencing nodes daisy-chained out from there. This could work well with, for example, an embodiment employing the USB standard. Obviously, such embodiments would require that each node have two USB ports.

In addition, embodiments of the invention are contemplated in which the hub device is simply another personal conferencing node. In some implementations, this “master” node includes the enhanced capabilities described above with reference to the hub device, while the other slave nodes do not. According to others, all of the nodes have the same capabilities. However, during operation one operates as the master node while the others operate as slaves. For example, when the system is powered up or when a call is being initiated, the nodes could negotiate among themselves to determine which device is to act as the masters. Alternatively, the node which is directly connected to the voice communication system is automatically designated as the master either in hardware or software.

Finally, although various advantages, aspects, and objects of the present invention have been discussed herein with reference to various embodiments, it will be understood that the scope of the invention should not be limited by reference to such advantages, aspects, and objects. For example, although true full-duplex operation may be facilitated by some embodiments of the invention, other embodiments are contemplated which do not necessarily provide that level of performance. Therefore, the scope of the invention should be determined with reference to the appended claims.

1. A conferencing system, comprising:
a plurality of conferencing devices, each conferencing device comprising a speaker, at least one microphone for capturing energy corresponding to near-end speech, a hub interface, and a first digital processor which is operable to process near-end signals corresponding to the near-end speech energy to improve intelligibility thereof, and transmit the processed near-end signals via the hub interface, the first digital processor further being operable to receive far-end signals via the hub interface, process the far-end signals, and transmit the processed far-end signals for presentation over the speaker;
a hub device comprising plurality of node interfaces operable to communicate with the hub interfaces of the conferencing devices, a voice system interface operable to communicate with a voice communication system, and a second digital processor operable to selectively combine the processed near-end signals received from the conferencing devices, transmit the combined processed near-end signals to the voice communication system via the system interface, receive the far-end signals from the voice communication system via the system interface, and transmit the far-end signals to the conferencing devices via the node interfaces.

2. The system of claim 1 wherein the node and hub interfaces comprise digital interfaces.

3. The system of claim 2 wherein the digital interfaces comprise one of wired interfaces and wireless interfaces.

4. The system of claim 3 wherein the wired interfaces comprise Universal Serial Bus (USB) interfaces, and the wireless interfaces comprise one of Bluetooth interfaces and wireless interfaces which comply with the IEEE 802.11 standard.

5. The system of claim 1 wherein the node and hub interfaces comprise analog interfaces.

6. The system of claim 5 wherein the analog interfaces comprise one of wired interfaces and wireless interfaces.

7. The system of claim 1 wherein the voice communication system corresponds to a telephone system and the voice system interface is operable to interface with phone signals from the telephone system.

8. The system of claim 7 wherein the phone signals are analog signals and the voice system interface is operable to receive the analog signals over a four wire interface.

9. The system of claim 8 wherein the four wire interface corresponds to a phone handset interface.

10. The system of claim 7 wherein the phone signals are analog signals and the voice system interface is operable to receive the analog signals over a two wire interface, the voice system interface comprising a hybrid.

11. The system of claim 7 wherein the phone signals are analog signals and the voice system interface comprises a wireless interface.

12. The system of claim 7 wherein the phone signals are digital signals and the voice system interface is operable to communicate with the telephone system according to a digital PBX protocol.

13. The system of claim 1 wherein the voice system interface is operable to interface with digital signals from the voice communication system.

14. The system of claim 13 wherein the voice system interface comprises one of a Universal Serial Bus (USB) interface, a Bluetooth interface, and a wireless interface which complies with the IEEE 802.11 standard.

15. The system of claim 13 wherein voice communication system comprises any of a digital phone system, a wireless communication network, a local area network, and a wide area network.

16. The system of claim 1 wherein the first digital processor is operable to selectively combine the near-end signals using a beam forming algorithm.

17. The system of claim 1 wherein the second digital processor is operable to selectively combine the processed near-end signals received from the conferencing devices using a beam forming algorithm.

18. The system of claim 1 wherein the second digital processor is operable to selectively combine the processed near-end signals received from the conferencing devices by deemphasizing the processed near-end signals from selected ones of the conferencing devices.

19. The system of claim 1 wherein the first digital processor is operable to reject noise associated with the near-end signals using at least one of a Wiener filter, a noise gate, and a spectral subtraction block.

20. The system of claim 1 wherein the first digital processor is operable to reject energy in the near-end signals corresponding to far-end speech.

21. The system of claim 1 wherein the second digital processor is operable to reject energy in the processed near-end signals corresponding to far-end speech.

22. The system of claim 1 wherein the first digital processor is operable to separate the near-end signals into a plurality of signal components each corresponding to one of a plurality of frequency bands, independently and dynamically control a dynamic range associated with each one of the plurality of signal components, modify at least one signal level associated with the plurality of signal components, and recombine the signal components.

23. The system of claim 1 wherein the first digital processor is operable to separate the far-end signals into a plurality of signal components each corresponding to one of a plurality of frequency bands, independently and dynamically control a dynamic range associated with each one of the plurality of signal components, modify at least one signal level associated with the plurality of signal components, and recombine the signal components.

24. The system of claim 1 wherein the first digital processor is operable to compensate for the non-ideal characteristics of the at least one speaker using a minimum phase filter.

25. The system of claim 1 wherein the second digital processor is operable to selectively transmit the far-end signals to the conferencing devices, thereby simulating nearend locations for far-end speakers.

26. The system of claim 1 wherein each of the conferencing devices comprises a battery and a first charging interface, and the hub device comprises a second charging interface and a connection to a power source, wherein the battery may be charged by the power source by interaction between the first and second charging interfaces.

27. The system of claim 26 wherein the interaction between the first and second charging interfaces is facilitated via one of inductive coupling and electrical coupling.

28. The system of claim 26 wherein each of the conferencing and hub devices comprises at least one magnet for securing the devices together to facilitate the interaction between the first and second charging interfaces.

29. The system of claim 1 wherein the node and hub interfaces comprise wired interfaces, and wherein power is provided to each of the conferencing devices via wires connecting the corresponding node and hub interfaces.

30. The system of claim 29 wherein the node and hub interfaces comprise Universal Serial Bus (USB) interfaces, and the wires comprise a USB cable.

31. The system of claim 1 wherein each of the hub interfaces is operable to communicate directly to a corresponding one of the node interfaces.

32. The system of claim 1 wherein each of the hub interfaces is operable to communicate to a corresponding one of the node interfaces via at least one other one of the hub interfaces.

33. The system of claim 1 wherein the hub device further comprises a keypad in communication with the second digital processor, the keypad being operable to facilitate interaction with the voice communication system.
